(19) United States
(12) Patent Application Publication
(10) Pub. No.: US 2011/0217165 A1
(43) Pub. Date: Sep. 8, 2011

(54) FAN FRAME STRUCTURE WITH INTEGRATED SINTERED OIL-IMPREGNATED BEARING THROUGH INSERT MOLDING AND METHOD OF MANUFACTURING THE SAME

(76) Inventor: Qi Ai, Sinjhuang City (TW)

(21) Appl. No.: 12/716,429

(22) Filed: Mar. 3, 2010

(51) Int. Cl. F04D 29/056; B29C 45/14

(52) U.S. Cl. 415/229; 264/278

(57) ABSTRACT

A fan frame structure with integrated sintered oil-impregnated bearing through insert molding and a method of manufacturing the same are provided. The fan frame includes a sintered oil-impregnated bearing and a fan frame. The bearing has a first and a second end face and an axially extended through hole communicating with the first and second end faces. The fan frame has a base and a bearing cup upward projected from the base to define an axial hollow space therein. The hollow space has a first and a second stop portion, and the bearing is received in the hollow space with the first and second end faces abutted on the first and second stop portions, respectively. With the sintered oil-impregnated bearing integrated with the fan frame through insert molding, increased concentricity between the bearing and the fan frame and reduced manufacturing cost of the fan frame structure can be ensured.

### FIELD OF THE INVENTION

The present invention relates to a fan frame structure with integrated sintered oil-impregnated bearing through insert molding and a method of manufacturing the same; and more particularly, to a fan frame structure with integrated sintered oil-impregnated bearing through insert molding and a method of manufacturing the same that ensure improved concentricity between the bearing and a bearing cup on the fan frame.

### BACKGROUND OF THE INVENTION

A bearing is an important component in a cooling fan mainly for keeping the rotary shaft of the fan in a stable operating state and minimizing the wearing of the rotary shaft. A good bearing structure is useful in extending the service life of the fan and reducing the noise produced by the fan during the operation thereof.

A sintered oil-impregnated bearing is a porous structure formed by sintering metal powder under high temperature and high pressure, and impregnating the porous structure with oil, so that the sintered oil-impregnated bearing has oil contained in its porous structure to produce a lubricating effect when the fan operates.

In a conventional way of manufacturing the cooling fan, a fan frame with a bearing cup is integrally formed using a plastic material through injection molding. Then, the bearing is fixedly positioned in the bearing cup by press-fitting. The bearing being press-fitted in the bearing cup tends to cause breaking and damage of the bearing cup as well as displacement of the bearing in the bearing cup and accordingly poor concentricity between the bearing and the bearing cup. Further, it is time and labor consuming to assemble the bearing to the bearing cup, which results in increased manufacturing cost. Therefore, it is tried by cooling fan manufacturers to dispose the bearing in an injection mold to be integrated with the fan frame through injection molding, so that the bearing is directly enclosed in the bearing cup to enable reduced labor and time and accordingly, reduced manufacturing cost. However, it is uneasy to control the concentricity of the bearing with the bearing cup, and the fan tends to sway and vibrate to adversely influence its service life. Moreover, when removing the injection molded fan frame from the mold, the bearing tends to be stuck to the mold, bringing difficulties in release the mold from the molded product. In brief, the conventional way of manufacturing cooling fan has the following disadvantages: (1) uneasy to control the concentricity of the bearing with the bearing cup; (2) shortened fan service life; (3) uneasy to remove the mold; and (4) increased fan manufacturing cost.

### SUMMARY OF THE INVENTION

A primary object of the present invention is to provide a fan frame structure with integrated sintered oil-impregnated bearing through insert molding, so as to reduce the manufacturing cost of a fan.

Another object of the present invention is to provide a method of manufacturing a fan frame structure with integrated sintered oil-impregnated bearing through insert molding.

A further object of the present invention is to provide a fan frame structure with integrated sintered oil-impregnated bearing through insert molding, so as to ensure increased concentricity between the bearing and a bearing cup on the fan frame.

To achieve the above and other objects, the fan frame structure with integrated sintered oil-impregnated bearing through insert molding according to the present invention includes a sintered oil-impregnated bearing and a fan frame. The sintered oil-impregnated bearing has a first and a second end face and an axially extended through hole communicating with the first and second end faces. The fan frame has a base and a bearing cup upward projected from the base to define an axial hollow space therein. The hollow space has a first and a second stop portion, and the bearing is received in the hollow space with the first and second end faces abutted on the first and second stop portions, respectively.

To achieve the above and other objects, the method of manufacturing a fan frame structure with integrated sintered oil-impregnated bearing through insert molding according to the present invention includes the steps of preparing a sintered oil-impregnated bearing and a mold unit having a mold cavity; inserting a central locating post in the mold cavity with the sintered oil-impregnated bearing fitted around the central locating post, and closing the mold unit; injecting a molten plastic material into the mold cavity of the mold unit, so that the sintered oil-impregnated bearing is integrated with the plastic material through insert molding; waiting until the plastic material is cooled and set to form a plastic item, opening the mold unit and removing the cooled and molded plastic item from the mold unit; and extracting the central locating post from the mold cavity to obtain a fan frame structure with integrated sintered oil-impregnated bearing through insert molding. The manufacturing method not only ensures increased concentricity between the bearing and the bearing cup on the fan frame, but also reduces the manufacturing cost of a fan. In brief, the present invention has the following advantages: (1) reducing the manufacturing cost of a fan; (2) ensuring increased concentricity between the bearing and fan frame; and (3) reducing labor and time needed to assemble the bearing to the fan frame.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a vertical sectional view of a fan frame structure according to the present invention;

FIG. 2 is a perspective sectional view of the fan frame structure of the present invention;

FIG. 3 is an exploded sectional view of a mold used to form the fan frame structure of the present invention;

FIG. 4 is assembled sectional view of the mold used to form the fan frame structure of the present invention;

FIG. 5 is a sectional view showing the forming of the fan frame structure of the present invention in the mold of FIG. 4; and

FIG. 6 is a flowchart showing the steps included in a method for manufacturing the fan frame structure of the present invention.

### DETAILED DESCRIPTION OF THE PREFERRED EMBODIMENTS

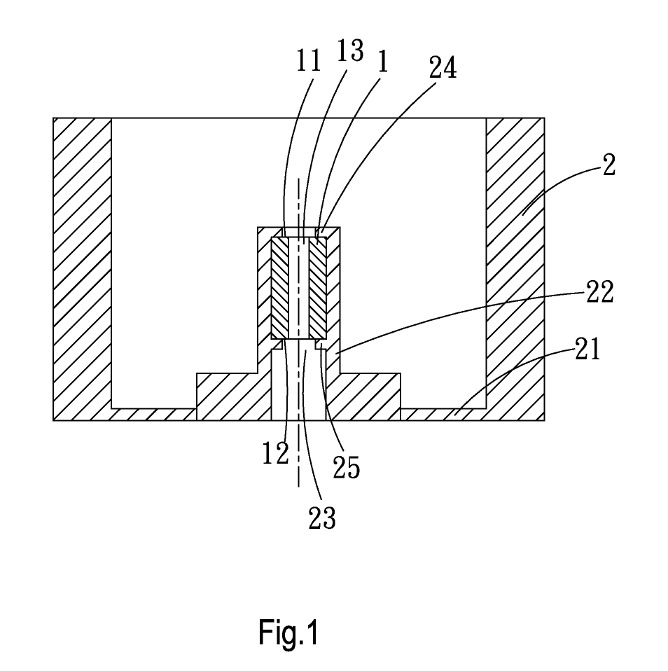

Please refer to FIG. 1. A fan frame structure with integrated sintered oil-impregnated bearing through insert molding according to the present invention includes a sintered oil-impregnated bearing 1 and a fan frame 2.

The sintered oil-impregnated bearing 1 has a first end face 11 and a second end face 12, and a through hole 13. The first and second end faces 11, 12 are separately located at two axially opposite ends of the sintered oil-impregnated bearing 1, and the through hole 13 axially extends through the bearing 1 to communicate with the first and second end faces 11, 12.

The fan frame 2 includes a base 21 and a bearing cup 22 upward extended from the base 21 by a predetermined length to define a hollow space 23 therein. The hollow space 23 axially extends through the bearing cup 22, and has a first stop portion 24 and a second stop portion 25. In an embodiment of the present invention, the first and the second stop portion 24, 25 are separately located in and continuously extended around the hollow space 23. The sintered oil-impregnated bearing 1 is received in the hollow space 23 with the first and second end faces 11, 12 abutted on the first and second stop portions 24, 25, respectively, so that the sintered oil-impregnated bearing 1 is held in place in the bearing cup 22 between the first and second stop portions 24, 25.

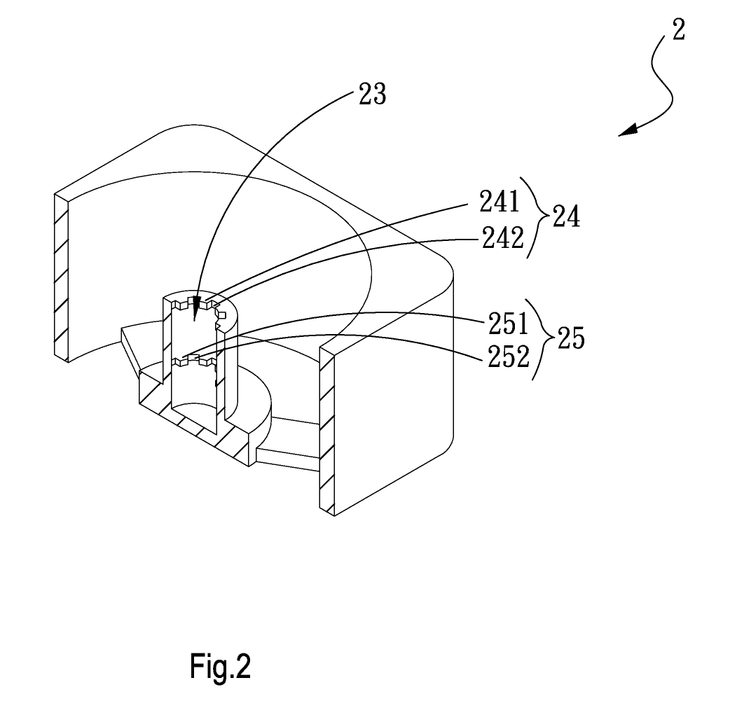

Please refer to FIG. 2 that is a perspective sectional view of the fan frame structure of the present invention. As shown, in another operable embodiment of the present invention, the first stop portion 24 can be located at and discontinuously extended around an end of the hollow space 23, and the second stop portion 25 can be located in and discontinuously extended around the hollow space 23. In this case, the first stop portion 24 includes a plurality of first stop sections 241 circumferentially spaced from one another at a first interval 242; and the second stop portion 25 includes a plurality of second stop sections 251 circumferentially spaced from one another at a second interval 252.

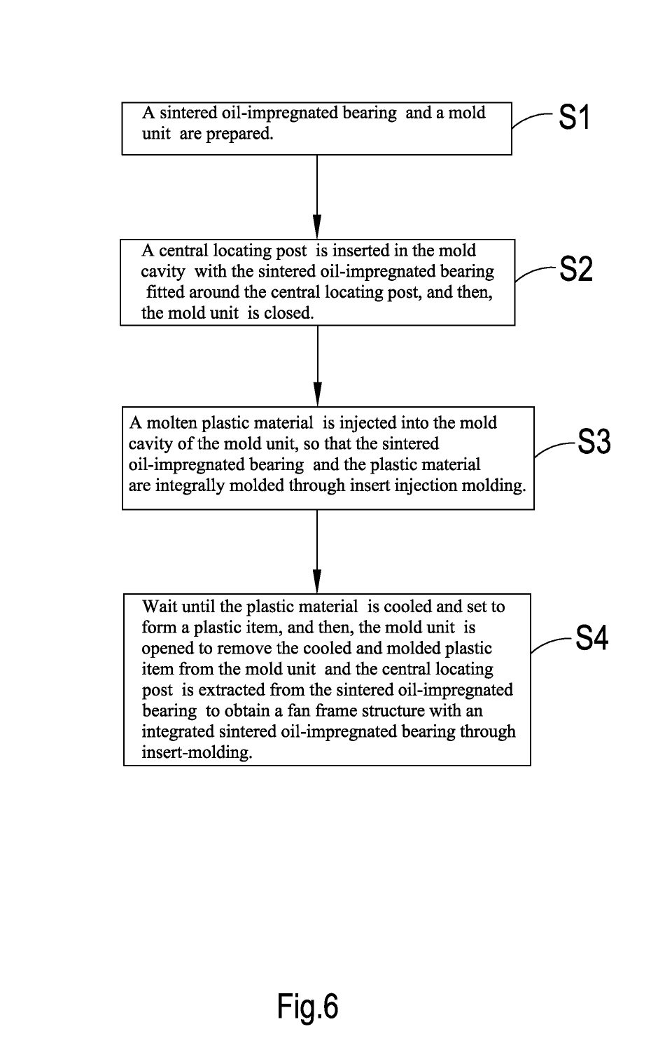

FIG. 6 is a flowchart showing the steps included in a method of manufacturing the fan frame structure with integrated sintered oil-impregnated bearing through insert molding according to the present invention. Please refer to FIG. 6 along with FIGS. 1, 3, 4 and 5.

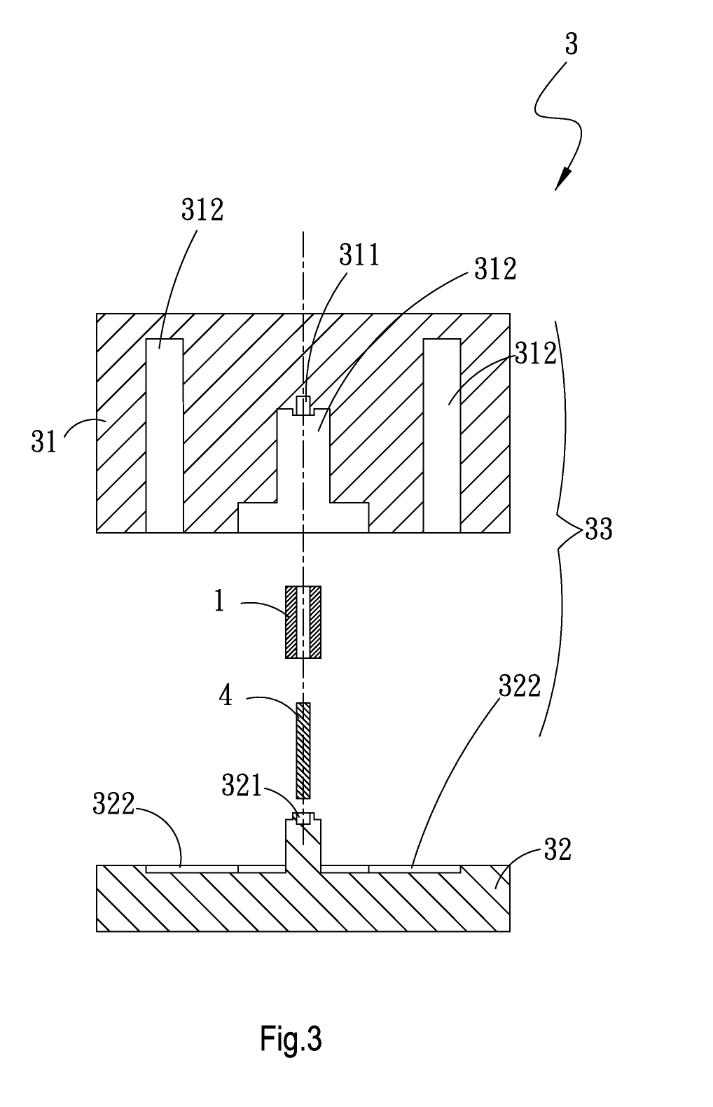

In a first step S1 of manufacturing the fan frame structure of the present invention, a sintered oil-impregnated bearing 1 and a mold unit 3 are prepared. The sintered oil-impregnated bearing 1 has a structure the same as that described above with reference to FIGS. 1 and 2, and is therefore not described again. As can be seen in FIG. 3, the mold unit 3 includes at least a top part 31 and a bottom part 32 to define a mold cavity 33 therebetween. The top part 31 has a first locating hole 311 and a first mold cavity 312; and the bottom part 32 has a second locating hole 321 and a second mold cavity 322. The first and second mold cavities 312, 322 together define and form the mold cavity 33.

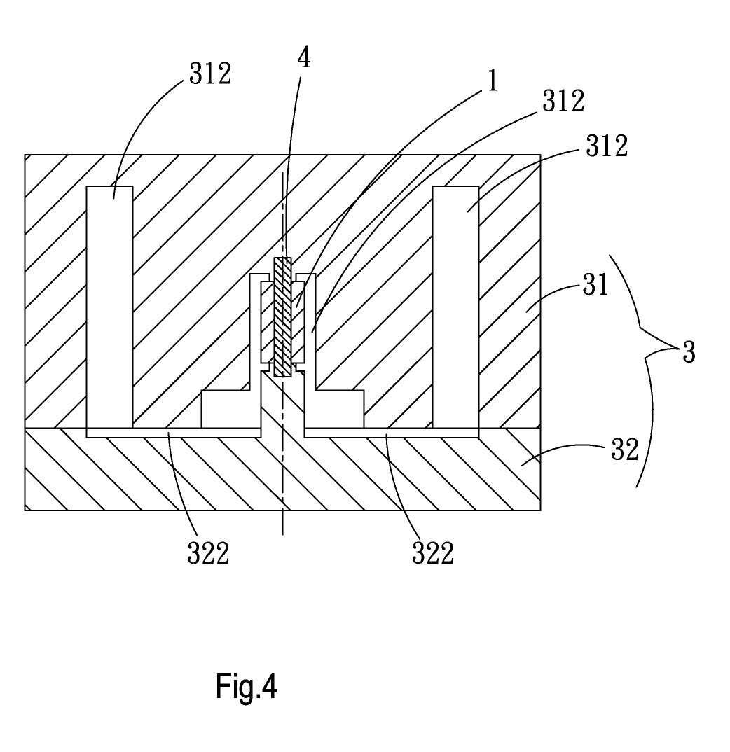

In a second step S2, a central locating post 4 is inserted in the mold cavity 33 with the sintered oil-impregnated bearing 1 fitted around the central locating post 4, and then, the mold unit 3 is closed. The central locating post 4 has two opposite ends separately inserted in the first and second locating holes 311, 321 in the top part 31 and bottom part 32 of the mold unit 3, respectively, so that the sintered oil-impregnated bearing 1 fitted around the central locating post 4 is held in place in the mold cavity 33 by the central locating post 4. Thereafter, the top part 31 and the bottom part 32 of the mold unit 3 are correspondingly closed to each other, as shown in FIG. 4.

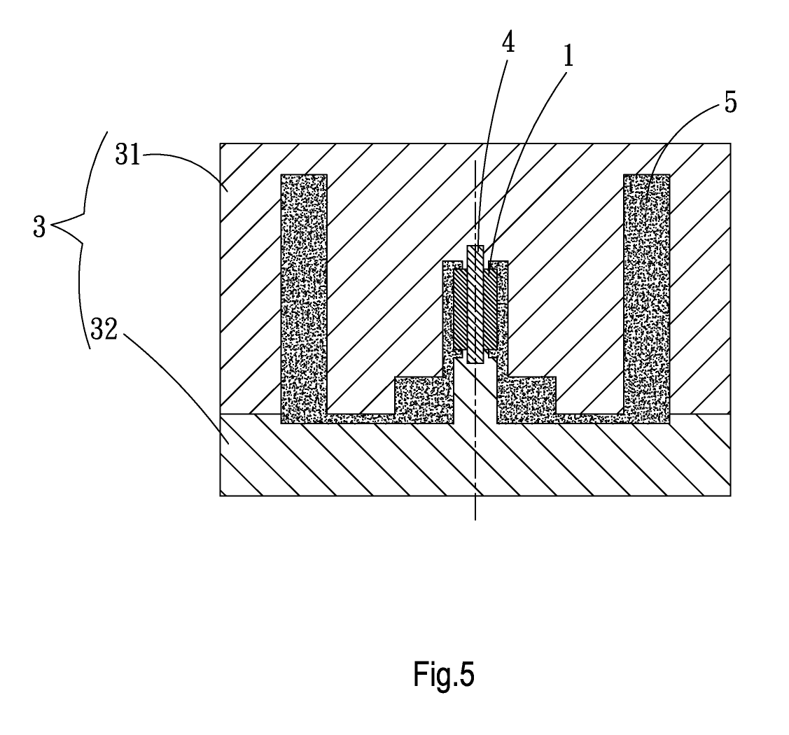

In a third step S3, a molten plastic material 5 is injected into the mold cavity 33 of the mold unit 3, so that the sintered oil-impregnated bearing 1 and the plastic material are integrally molded through insert injection molding, as shown in FIG. 5. The molten plastic material 5 fills up the whole mold cavity 33 to thereby enclose the sintered oil-impregnated bearing 1 in the plastic material 5, allowing the sintered oil-impregnated bearing 1 and the plastic material 5 to be integrally molded through insert injection molding and form a fan frame 2 as that shown in FIG. 1, and the sintered oil-impregnated bearing 1 is stably located in a bearing cup 22 of the fan frame 2.

In a fourth step S4, wait until the plastic material 5 is cooled and set to form a plastic item, and then, the mold unit 3 is opened to remove the cooled and molded plastic item from the mold unit 3 and the central locating post 4 is extracted from the sintered oil-impregnated bearing 1 to obtain a fan frame structure with an integrated sintered oil-impregnated bearing through insert-molding. When the plastic material 5 in the mold cavity 33 of the mold unit 3 is cooled and set, the top part 31 and the bottom part 32 of the mold unit 3 can be separated from each other to remove the molded plastic item from the mold unit 3. The molded plastic item is an integrally insert-molded structural body of the fan frame 2 and the sintered oil-impregnated bearing 1. The central locating post 4 fitted in the sintered oil-impregnated bearing 1 is then extracted from the integrally insert-molded structural body.

According to the present invention, the sintered oil-impregnated bearing 1 is oil-impregnated in advance.

Unlike conventional fan frame molding techniques, in which a central locating post is integrally formed with the top part or the bottom part of the mold, the central locating post 4 in the present invention is held in the mold unit 3 by inserting two opposite ends of the post 4 in the first and second locating holes 311, 321 on the top and bottom parts 31, 32, respectively, as shown in FIG. 3. Since the central locating post 4 is not integrally formed with the top part 31 or the bottom part 32 of the mold unit 3, the molded plastic item can be more quickly and conveniently removed from the mold unit 3. With the present invention, labor and time needed to assemble the bearing to the fan frame can be reduced and a high concentricity of the sintered oil-impregnated bearing 1 with the fan frame 2 can be ensured to also increase the quality and service life of the insert-molded fan frame structure.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A fan frame structure with integrated sintered oil-impregnated bearing through insert molding, comprising:
a sintered oil-impregnated bearing having a first end face, a second end face, and a through hole; and the through hole axially extending through the bearing to communicate with the first and second end faces; and
a fan frame including a base and a bearing cup upward extended from the base by a predetermined length to define a hollow space therein; the hollow space axially extending through the bearing cup, and having a first stop portion and a second stop portion; and the sintered oil-impregnated bearing being received in the hollow space with the first and second end faces of the bearing abutted on the first and second stop portions of the hollow space, respectively.

2. The fan frame structure with integrated sintered oil-impregnated bearing through insert molding as claimed in claim 1, wherein the first stop portion is located in and continuously extended around the hollow space.

3. The fan frame structure with integrated sintered oil-impregnated bearing through insert molding as claimed in claim 1, wherein the first stop portion is located in and discontinuously extended around the hollow space.

4. The fan frame structure with integrated sintered oil-impregnated bearing through insert molding as claimed in claim 1, wherein the second stop portion is located in and continuously extended around the hollow space.

5. The fan frame structure with integrated sintered oil-impregnated bearing through insert molding as claimed in claim 1, wherein the second stop portion is located in and discontinuously extended around the hollow space.

6. The fan frame structure with integrated sintered oil-impregnated bearing through insert molding as claimed in claim 3, wherein the first stop portion includes a plurality of first stop sections circumferentially spaced from one another at a first interval.

7. The fan frame structure with integrated sintered oil-impregnated bearing through insert molding as claimed in claim 5, wherein the second stop portion includes a plurality of second stop sections circumferentially spaced from one another at a second interval.

8. A method of manufacturing fan frame structure with integrated sintered oil-impregnated bearing through insert molding, comprising the following steps:
preparing a sintered oil-impregnated bearing and a mold unit having a mold cavity;
inserting a central locating post in the mold cavity with the sintered oil-impregnated bearing fitted around the central locating post, and closing the mold unit;
injecting a molten plastic material into the mold cavity of the mold unit, so that the sintered oil-impregnated bearing is integrated with the plastic material through insert molding; and
waiting until the plastic material is cooled and set to form a plastic item, opening the mold unit and removing the cooled and molded plastic item from the mold unit, and extracting the central locating post from the sintered oil-impregnated bearing to obtain a fan frame structure with integrated sintered oil-impregnated bearing through insert molding.

9. The method of manufacturing fan frame structure with integrated sintered oil-impregnated bearing through insert molding as claimed in claim 8, wherein the mold unit includes a top part and a bottom part; the top part having a first locating hole and a first mold cavity, and the bottom part having a second locating hole and a second mold cavity; the central locating post being inserted in the mold cavity by separately inserting two opposite ends in the first and second locating holes; and the first and second mold cavities together defining and forming the mold cavity in the mold unit.

10. The method of manufacturing fan frame structure with integrated sintered oil-impregnated bearing through insert molding as claimed in claim 8, wherein the sintered oil-impregnated bearing has a first end face, a second end face, and a through hole; and the through hole axially extending through the bearing to communicate with the first and second end faces.

11. The method of manufacturing fan frame structure with integrated sintered oil-impregnated bearing through insert molding as claimed in claim 8, wherein the sintered oil-impregnated bearing is impregnated with oil in advance.
